(19) United States
(12) Patent Application Publication
(10) Pub. No.: US 2026/0136445 A1
(43) Pub. Date: May 14, 2026

(54) ANTI-PARALLEL LED CONFIGURED LIGHTING DISPLAY

(71) Applicant: Eastern Lite International Limited, Kowloon (HK)

(72) Inventors: Jason A. Loomis, Decatur, GA (US); Yixin Long, Jiangmen City (CN)

(21) Appl. No.: 19/377,769

(22) Filed: Nov. 3, 2025

Related U.S. Application Data
(60) Provisional application No. 63/715,344, filed on Nov. 1, 2024.

(51) Int. Cl. H05B 45/59; H05B 45/42

(52) U.S. Cl. CPC H05B 45/59; H05B 45/42

(57) ABSTRACT

Apparatus and associated methods relate to providing low-flicker illumination from LED lighting elements of an AC-powered decorative lighting display without having to provide bridge rectification of an AC power source. The AC decorative lighting display includes a plurality of lighting nodes wired in in a series-connected sequence of lighting nodes. The series-connected sequence is directly and conductively connected between the first and second electrical contacts so as to receive AC operating power therefrom. Each of the plurality of lighting nodes includes first and second Light Emitting Diodes (LEDs) wired in anti-parallel fashion. Each of the lighting nodes of the AC-powered decorative lighting display includes two LEDs wired in anti-parallel fashion.

### CROSS-REFERENCE TO RELATED APPLICATION

This application claims priority to U.S. Provisional Application No. 63/715,344 filed Nov. 1, 2024 and entitled “ANTI-PARALLEL LED CONFIGURED LIGHTING DISPLAY,” the disclosure of which is hereby incorporated by reference in its entirety.

### BACKGROUND

Lighting displays are used to communicate the joy of a holiday season, to draw attention to merchandise, or to simply decorate or adorn an object or structure. Lighting displays can be used both indoors and outdoors. Lighting displays have been used residentially to adorn trees, shrubs, and houses. Commercial businesses have used lighting displays to provide festive atmospheres at their places of business. Even vehicles can be equipped with decorative lighting elements. Many such lighting displays use a great many lighting elements, such as, for example, light strings.

In more recent times, Light Emitting Diodes (LEDs) are being used in many, if not most, lighting displays. LEDs emit light only when biased in a forward-bias manner. As such, if Alternating Current (AC) operating power is used to bias a light string of LED lighting elements, the LED lighting elements provide illumination only during a half-cycle of an AC operating cycle. Some light strings are equipped with a bridge rectifier so as to enable the LED lighting elements to provide Direct Current (DC) operating power to the LED lighting elements, thereby causing illumination during both half-cycles of the AC operating cycle. LEDs have a current-voltage relation that is characterized by forward current that is exponentially related to forward voltage. Light strings are designed so that the average forward bias is approximately an on-voltage that provides both good illumination and long operating lifetimes of the LED lighting elements. The current-voltage relation of the reverse bias is characterized by a breakdown voltage that is typically greater than a forward bias on-voltage. Therefore, when the opposite polarity of the on-voltage is provided across an LED lighting element, very little electrical current is typically produced.

### SUMMARY

Some embodiments relate to a decorative lighting display that includes an electrical connector and a plurality of lighting nodes. The electrical connector has a first electrical contact and a second electrical contact. The first electrical contact and the second electrical contact are configured to receive Alternating Current (AC) operating power in response to being connected to an AC power source. The plurality of lighting nodes is wired in series as a series-connected sequence of lighting nodes. The series-connected sequence of lighting nodes are directly and conductively connected between the first and second electrical contacts so as to receive the AC operating power therefrom. Each of the plurality of lighting nodes includes a first Light Emitting Diode (LED) and a second LED diode wired in anti-parallel fashion.

Some embodiments relate to a decorative light string. The decorative light string includes a first electrical connector located at a first end of the decorative light string. The first electrical connector has a first electrical contact and a second electrical contact. The first electrical contact and the second electrical contact are configured to receive Alternating Current (AC) operating power in response to the first electrical connector being connected to an AC power source. The decorative light string includes a second electrical connector at a second end of the decorative light string. The second electrical connector has a third electrical contact and a forth electrical contact. The third electrical contact and the fourth electrical contact configured to provide the AC operating power to another decorative light string connected to the second electrical connector. The decorative light string includes a first electrical conductor electrically coupled to and extending from the first electrical contact of the first electrical connector to the third electrical contact of the second electrical connector. The decorative light string includes a second electrical conductor electrically coupled to and extending from the second electrical contact of the first electrical connector to the fourth electrical contact of the second electrical connector. The decorative light string also includes a plurality of lighting nodes distributed along the decorative light string. The plurality of lighting nodes is wired in series as a series-connected sequence of lighting nodes. The series-connected sequence of lighting nodes is conductively connected between the first electrical contact and the second electrical contact so as to receive the AC operating power therefrom. Each of the plurality of lighting nodes including a first Light Emitting Diode (LED) and a second LED wired in anti-parallel fashion.

Some embodiments relate to a decorative lighting display comprising electrical current-conducting components that are configured to conduct electrical current, the electrical current-conducting components consist of conductive elements and LED. The conductive elements and Light Emitting Diodes (LEDs), wherein the conductive elements include an electrical connector having a first electrical contact and a second electrical contact. The first electrical contact and the second electrical contact are configured to receive Alternating Current (AC) operating power in response to being connected to an AC power source. The LEDs are wired in series as a series-connected sequence of lighting nodes, the series-connected sequence of lighting nodes directly and conductively connected between the first and second electrical contacts so as to receive the AC operating power therefrom. Each of the plurality of lighting nodes including a first Light Emitting Diode (LED) and a second LED diode wired in anti-parallel fashion.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of light string with LED lighting elements configured in an anti-parallel manner.

FIG. 2 is a graph of a relation between LED illumination and time for an anti-parallel configured lighting node.

FIG. 3 is a graph of an example current-voltage relation for a single LED lighting element.

### DETAILED DESCRIPTION

Apparatus and associated methods relate to providing low-flicker illumination from LED lighting elements of an AC-powered decorative lighting display without having to provide bridge rectification of an AC power source. The AC decorative lighting display includes a plurality of lighting nodes wired in in a series-connected sequence of lighting nodes. The series-connected sequence is conductively connected between the first and second electrical conductors so as to receive AC operating power therefrom. Each of the plurality of lighting nodes includes first and second Light Emitting Diodes (LEDs) wired in anti-parallel fashion. Each of the lighting nodes of the AC-powered decorative lighting display includes two LEDs wired in anti-parallel fashion.

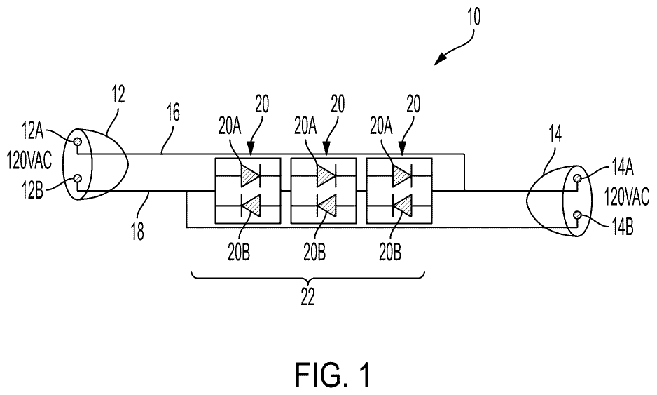

FIG. 1 is a schematic diagram of light string with LED lighting elements configured in an anti-parallel manner. In FIG. 1, light string 10 includes first and second electrical connectors 12 and 14, first and second electrical conductors 16 and 18, and lighting nodes 20. First electrical connector 12 is located at a first end of decorative light string 10. First electrical connector 12 has first and second electrical contacts 12A and 12B. First electrical connector 12 is configured to receive Alternating Current (AC) operating power on first and second electrical contacts 12A and 12B. For example, first electrical contact 12A and second electrical contact 12B can be configured to receive 110 V AC operating power in response to being connected to a 110 V AC power source. Second electrical connector 14 is located at a second end of decorative light string 10. Second electrical connector 14 has first and second electrical contacts 14A and 14B. First electrical conductor 16 is electrically coupled to and extends from first electrical contact 12A of first electrical connector 12 to first electrical contact 14A of second electrical connector 14. Second electrical conductor 18 is electrically coupled to and extending from second electrical contact 12B of first electrical connector 12 to second electrical contact 14B of second electrical connector 14. Typically, first and second electrical connectors are complementary to one another, thereby facilitating connection of a series of light strings 10. For example, first electrical connector 12 can be a male connector, and second electrical connector 14 can be a female connector that is complementary to first electrical connector 12.

Lighting nodes 20 are distributed along decorative light string 10. Lighting nodes 20 are wired in series in a series-connected sequence 22 of lighting nodes 20. Although in the FIG. 1 embodiment, series-connected sequence 22 has only three lighting nodes 20, typically many more than three lighting nodes are in the series-connected sequences of decorative lighting displays. Series-connected sequence 22 is directly and conductively connected between first and second electrical conductors 16 and 18, thereby being configured to receive the AC operating power therefrom. The term ‘directly and conductively connected’ means that conductive connection is made without other electrical components, such as, for example, a bridge rectifier. Each of lighting nodes 20 includes first and second Light Emitting Diodes (LEDs) 20A and 20B wired in anti-parallel fashion. Anti-parallel fashion refers to connection in which an anode and a cathode of first LED 20A are conductively connected to the cathode and anode, respectively, of second LED 20B in each of the plurality of lighting nodes. In some embodiments each lighting node comprising anti-parallel LEDs 20A and 20B are fabricated on a substrate common to both anti-parallel LEDs 20A and 20B. Such a substrate can include material, such as, for example, silicon, silicon carbide, sapphire, and/or aluminum.

Because LEDs provide illumination only in response to one polarity of bias applied thereacross, first LED 20A of each of lighting nodes 20 provides illumination in response to receiving electrical power during a first half-cycle of the AC operating power. First LED 20A of each of lighting nodes 20 does not provide illumination in response to receiving electrical power during a second half-cycle of the AC operating power. For this same reason, second LED 20B of each of lighting nodes 20 provides illumination in response to receiving electrical power during a second half-cycle of the AC operating power. Second LED 20B of each of lighting nodes 20 does not provide illumination in response to receiving electrical power during a second half-cycle of the AC operating power. Because each of first and second LEDS 20A and 20B provide illumination in such a complementary fashion, low-flicker illumination is provided, without having to rectify the AC operating power. Such low-flicker light strings can be produced with fewer components and lower costs than bridge-rectified light strings.

In some embodiments, illumination can be sustained after each of first and second LEDs 20A and 20B have stopped illumination during their respective half-cycles. For example, in some embodiments, lighting nodes 20 can include a lens coated with a photoluminescent phosphor material that sustains illumination after each of first and second LEDs 20A and 20B have stopped illumination during their respective half-cycles. In some embodiments, the photoluminescent phosphor material has an illumination half-life of greater than a time period of a half cycle of the AC operating power. Other types of lighting displays can use such anti-parallel configurations to provide low-flicker illumination.

Although the lighting display of the FIG. 1 is depicted as a light string, any lighting display can use such anti-parallel configuration of lighting nodes, thereby rendering bridge rectification of AC power unnecessary. Note that the embodiment depicted in FIG. 1 has few types of electrical current-conducting components (i.e., components that are configured to conduct electrical current). In FIG. 1, the electrical current-conducting components of light string 10 includes only conductive elements, such as wires and connector contacts, and LEDs. No rectifying diodes, resistors, capacitors, etc. are used. The term ‘conductive elements’ means elements that conduct electrical currents for the purpose of electrical connection only. Such conductive elements include low-resistance components (i.e., less than a few ohms, and typically much less than one ohm), such as, for example, conductive wires, pins, contacts, solder, etc. Such conductive elements typically are made of various conductive metals. The term ‘conductive elements’ excludes components that are configured to convert the electrical current to some performative function. These excluded components include resistors, capacitors, rectifying diodes, transistors, inductors, and other such components that have known functions to persons of skill in the art.

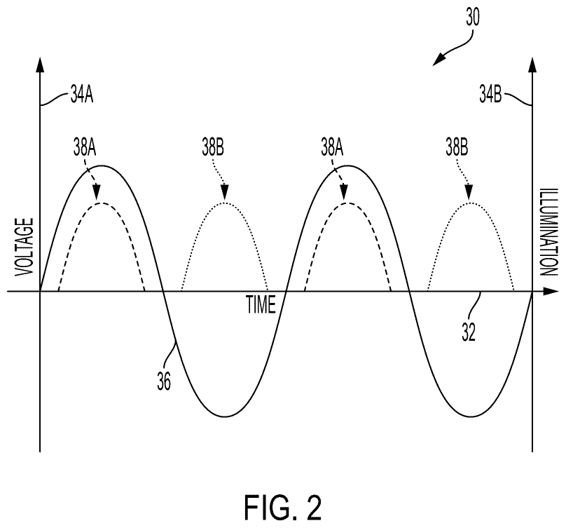

FIG. 2 is a graph of a relation between LED illumination and time for an anti-parallel configured lighting node. In FIG. 2, graph 30 includes horizontal axis 32, vertical axes 34A and 34B, voltage-time relation 36 and illumination-time relations 38A and 38B. Horizontal axis is indicative of time t. Vertical axes 34A and 34B are indicative of voltage and illumination, respectively. Voltage-time relation 36 depicts the voltage of the AC operating power as received by first electrical connector 12 (depicted in FIG. 1). Illumination-time relation 38A is indicative of illumination of first LED 20A of each of lighting nodes 20 as a function of time. As indicated by illumination-time relation 38A, first LEDs 20A begin illuminating in response to the forward bias thereacross exceeding some threshold value, and end illuminating in response to the forward bias thereacross dipping below that threshold value. Similarly, illumination-time relation 38B, second LEDs 20B begin illuminating in response to the forward bias thereacross exceeding the threshold value, and end illuminating in response to the forward bias thereacross dipping below that threshold value. Because first and second LEDS 20A and 20B are configured in anti-parallel fashion, LEDS 20A and 20B provide illumination at complementary times (i.e., during alternate half cycles of the AC operating power).

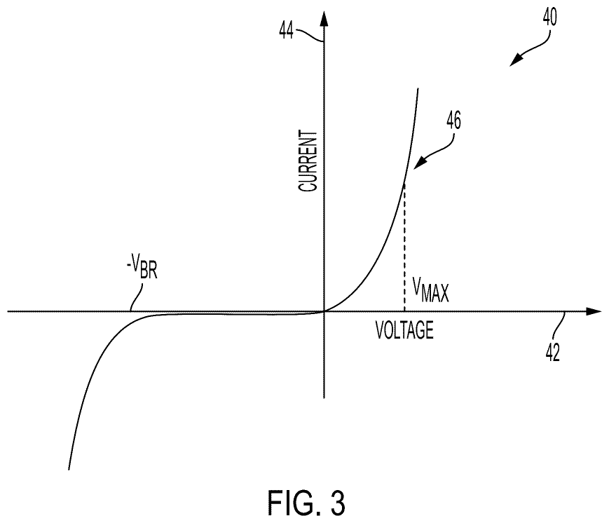

FIG. 3 is a graph of an example current-voltage relation for a single LED lighting element. In FIG. 3, graph 40 includes horizontal axis 42, vertical axis 44, and current-voltage relation 46. Horizontal axis is indicative of voltage applied across a single LED (e.g., across one of first or second LEDs 20A or 20B). Vertical axis 44 is indicative of the current conducted by the single LED. Current-voltage relation 46 includes forward bias portion 46+ and reverse bias portion 46−. Only in forward bias portion, will the single LED provide illumination. During the half-cycle of AC operating power that provides forward biasing of the single LED (e.g., a first half-cycle), the voltage thereacross is configured not to exceed a maximum forward-bias voltage drop V_{MAX}. Such a maximum forward-bias voltage drop can be determined, for example, by dividing a voltage peak of the AC operating power by the number of series-connected LEDS in the light string. During the half-cycle of AC operating power that provides reverse biasing of the single LED (e.g., a second half-cycle), current is very small, at least while the reverse-bias voltage thereacross does not exceed the breakdown voltage V_{BR}. If breakdown voltage V_{BR} is greater the maximum forward-bias voltage drop V_{MAX}, very little electrical current will be conducted via the reverse-biased LED.

It will be recognized that the invention is not limited to the implementations so described, but can be practiced with modification and alteration without departing from the scope of the appended claims. For example, the above implementations may include specific combination of features. However, the above implementations are not limited in this regard and, in various implementations, the above implementations may include the undertaking only a subset of such features, undertaking a different order of such features, undertaking a different combination of such features, and/or undertaking additional features than those features explicitly listed. The scope of the invention should, therefore, be determined with reference to the appended claims, along with the full scope of equivalents to which such claims are entitled.

1. A decorative lighting display comprising:
an electrical connector having a first electrical contact and a second electrical contact, wherein first electrical contact and the second electrical contact are configured to receive Alternating Current (AC) operating power in response to being connected to an AC power source; and
a plurality of lighting nodes wired in series as a series-connected sequence of lighting nodes, the series-connected sequence of lighting nodes directly and conductively connected between the first and second electrical contacts so as to receive the AC operating power therefrom, each of the plurality of lighting nodes including a first Light Emitting Diode (LED) and a second LED diode wired in anti-parallel fashion.

2. The decorative lighting display of claim 1, wherein, for each of the plurality of lighting nodes, the first LED has a first anode and a first cathode, the first anode is conductively connected to the first electrical contact and the first cathode in conductively connected to second electrical contact, the first LED has a second anode and a second cathode, the second anode is conductively connected to the second electrical contact and the second cathode in conductively connected to first electrical contact.

3. The decorative lighting display of claim 1, wherein the decorative lighting display has no rectifying diodes configured to rectify the AC operating power received via the electrical connector so as to provide DC operating power to the series-connected sequence of lighting nodes.

4. The decorative lighting display of claim 1, wherein the first LED of each of the plurality of lighting nodes provides illumination in response to receiving electrical power during a first half-cycle of the AC operating power and the second LED of each of the plurality of lighting nodes provides illumination in response to receiving electrical power during a second half-cycle of the AC operating power.

5. The decorative lighting display of claim 4, wherein the first LED of each of the plurality of lighting nodes does not provide illumination in response to receiving electrical power during a second half-cycle of the AC operating power and the second LED of each of the plurality of lighting nodes does not provide illumination in response to receiving electrical power during a second half-cycle of the AC operating power.

6. The decorative lighting display of claim 1, wherein a first anode and a first cathode of the first LED is conductively connected to a second cathode and a second anode, respectively, of the second LED for each of the plurality of lighting nodes.

7. The decorative lighting display of claim 1, wherein each of the plurality of lighting nodes includes a lens coated with a photoluminescent phosphor material that sustains illumination after each of the first and second LEDs have stopped illumination during its respective half-cycles.

8. The decorative lighting display of claim 7, wherein the photoluminescent phosphor material has an illumination half-life of greater than a time period of a half cycle of the AC operating power.

9. The decorative lighting display of claim 1, wherein the first and second LEDs of each of the plurality of lighting nodes is fabricated on a substrate common to the first and second LEDs.

10. The decorative lighting display of claim 9, wherein the substrate common to the first and second LEDs comprises silicon carbide, silicon, sapphire, aluminum.

11. A decorative light string comprising:
a first electrical connector located at a first end of the decorative light string, the first electrical connector having a first electrical contact and a second electrical contact, wherein the first electrical contact and the second electrical contact are configured to receive Alternating Current (AC) operating power in response to the first electrical connector being connected to an AC power source;
a second electrical connector at a second end of the decorative light string, the second electrical connector having third electrical contact and a fourth electrical contact, wherein the third electrical contact and the fourth electrical contact configure to provide AC operating power to another light string connected to the second electrical connector;
a first electrical conductor electrically coupled to and extending from the first electrical contact of the first electrical connector to the third electrical contact of the second electrical connector;
a second electrical conductor electrically coupled to and extending from the second electrical contact of the first electrical connector to the fourth electrical contact of the second electrical connector; and
a plurality of lighting nodes distributed along the decorative light string, the plurality of lighting nodes wired in series as a series-connected sequence of lighting nodes, the series-connected sequence of lighting nodes conductively connected between the first electrical conductor and the second electrical conductor so as to receive the AC operating power therefrom, each of the plurality of lighting nodes including a first Light Emitting Diode (LED) and a second LED wired in anti-parallel fashion.

12. The decorative lighting string of claim 11, wherein, for each of the plurality of lighting nodes, the first LED has a first anode and a first cathode, the first anode is conductively connected to the first electrical contact and the first cathode in conductively connected to second electrical contact, the first LED has a second anode and a second cathode, the second anode is conductively connected to the second electrical contact and the second cathode in conductively connected to first electrical contact.

13. The decorative light string of claim 11, wherein the second electrical connector is complementary to the first electrical connector.

14. The decorative light string of claim 11, wherein the decorative light string has no rectifying diodes configured to rectify the AC operating power received via the first electrical connector so as to provide DC operating power to the series-connected sequence of lighting nodes.

15. The decorative light string of claim 11, wherein the first LED of each of the plurality of lighting nodes provides illumination in response to receiving electrical power during a first half-cycle of the AC operating power and the second LED of each of the plurality of lighting nodes provides illumination in response to receiving electrical power during a second half-cycle of the AC operating power.

16. The decorative light string of claim 15, wherein the first LED of each of the plurality of lighting nodes does not provide illumination in response to receiving electrical power during a second half-cycle of the AC operating power and the second LED of each of the plurality of lighting nodes does not provide illumination in response to receiving electrical power during a second half-cycle of the AC operating power.

17. The decorative light string of claim 11, wherein a first anode and a first cathode of the first LED is conductively connected to a second cathode and a second anode, respectively, of the second LED in each of the plurality of lighting nodes.

18. The decorative light string of claim 11, wherein each of the plurality of lighting nodes includes a lens coated with a photoluminescent phosphor material that sustains illumination after each of the first and second LEDs have stopped illumination during its respective half-cycles.

19. The decorative light string of claim 11, wherein the first and second LEDs of each of the plurality of lighting nodes is fabricated on a substrate common to the first and second LEDs.

20. A decorative lighting display comprising electrical current-conducting components that are configured to conduct electrical current, the electrical current-conducting components consisting of:
conductive elements and Light Emitting Diodes (LEDs), wherein the conductive elements include:
an electrical connector having a first electrical contact and a second electrical contact, wherein the first electrical contact and the second electrical contact are configured to receive Alternating Current (AC) operating power in response to being connected to an AC power source,
wherein the LEDs are wired in series as a series-connected sequence of lighting nodes, the series-connected sequence of lighting nodes directly and conductively connected between the first and second electrical contacts so as to receive the AC operating power therefrom, each of the plurality of lighting nodes including a first Light Emitting Diode (LED) and a second LED diode wired in anti-parallel fashion.
